(19) United States
(12) Patent Application Publication
(10) Pub. No.: US 2008/0280122 A1
(43) Pub. Date: Nov. 13, 2008

(54) Integrating non-elongated security particles in value documents

(76) Inventors: Karel Soete, Kalken (Laarne) (BE); Carl Vromant, De Pinte (BE); Dominique Santens, Koksijde (BE)

Correspondence Address: SHLESINGER, ARKWRIGHT & GARVEY LLP, 1420 KING STREET, SUITE 600, ALEXANDRIA, VA, 22314, US

(21) Appl. No.: 12/149,458

(22) Filed: May 1, 2008

Related U.S. Application Data
(63) Continuation of application No. PCT/EP2006/066371, filed on Sep. 14, 2006.

(30) Foreign Application Priority Data
Nov. 8, 2005 (EP) EP 05110473.5

(51) Int. Cl. B32B 5/16; B28B 3/02

(52) U.S. Cl. 428/304.4; 428/221; 264/319

(57) ABSTRACT

A coherent sheet-like or tape-like product adapted to be integrated into value products or documents, includes non-elongated security particles in the form of metal particles or metal coated particles, and includes a paper or plastic compatible binder. The sheet-like or tape-like product provides a better controllable concentration of the security particles and an easy integration of the security particles into the value documents.

### CROSS-REFERENCE TO RELATED APPLICATIONS

This application is a continuation of application no. PCT/EP2006/066371, filed Sep. 14, 2006, which claims the priority of European patent application no. 05110473.5, filed Nov. 8, 2005, and each of which is incorporated herein by reference.

### FIELD OF THE INVENTION

The present invention relates to a coherent sheet-like or tape-like product with security particles. According to a second aspect, the present invention also relates to a value document comprising such a sheet-like or tape-like product. According to a third aspect, the invention relates to two methods of manufacturing a sheet-like or tape-like product.

### BACKGROUND OF THE INVENTION

It is known to integrate security particles into substrates for authentication or identification purposes of value documents. U.S. Pat. No. 4,408,156, EP-B-0 236 365 and EP-B-0 897 569 are only examples of prior art documents describing such value documents.

U.S. Pat. No. 4,265,703 discloses a method of integrating security particles in the form of metal fibers into a fibrous structure such as paper. Indeed, the difference in specific gravity between metal fibers and paper-like material makes a homogeneous distribution of the metal fibers in a paper substrate difficult, if no precautions are taken. The precautions taken by U.S. Pat. No. 4,265,703 consist in subjecting a bundle of metal particles to a bath of a hydro soluble binder so as to make a coated bundle. The hydro soluble binder is either polyvinyl alcohol or starch. Hereafter, the fiber bundle is dried and cut into predetermined lengths of agglomerates binder-fiber. The agglomerates are mixed with paper particles to form a sheet-like structure where the metal particles are homogeneously distributed. The binder material serves as material for separating the filaments.

Despite successful application of this method, variations in concentrations of the particles in the substrate are experienced. When the security level to be provided by the particles also depends upon the concentration of the particles in the substrate, these variations in concentrations are unacceptable.

The method described in U.S. Pat. No. 4,265,703 can also be applied to incorporate metal particles at limited locations in value documents. These limited locations may take the form of bands or strips. Experience has shown that it is difficult to keep the width of such bands or strips within predetermined narrow limits. Furthermore, some dimensions, e.g. very small widths, are not obtainable. Here again, when the security level to be provided by the metal particles also depends on the exact geographical location of the metal particles in the value document, too big a variation in this geographical location is not acceptable.

### SUMMARY OF THE INVENTION

It is an object of the present invention to avoid the drawbacks of the prior art.

It is another object of the present invention to provide more control of the concentration of security particles in the substrate of a value document.

It is yet another object of the present invention to provide for exactly determined geographical locations with security particles within a security document.

It is still another object of the present invention to provide for a robust method of integrating security particles into a value document, largely independent of the way of manufacturing the value documents. According to a first aspect of the present invention, there is provided a coherent sheet-like or tape-like product adapted to be integrated into value products or documents. The product comprises:
a) non-elongated security particles;
b) a paper or plastic compatible binder.

In the context of the present invention, the terms “value documents” refer to all types of valuable documents such as bank notes, bonds, passports, credit-cards, access tickets, The security particles are be either integrated into or onto the documents.

The terms “non-elongated security particles” are used in order to make a distinction with fiber-like products and refer to particles where the various dimensions (e.g. length, width, depth) can vary with respect to each other only to a limited extent, e.g. to a factor less than 10, preferably less than 6, e.g. less than 5. The terms “non-elongated particles” cover powders, small spheres, pigments and the like. The absolute values of the dimensions are smaller than the ultimate thickness of the final value documents.

In order to function as “security particles”, the particles have parameters, which are detectably different from the substrate material. The detectable difference may take various forms such as optical difference (e.g. difference in reflection or absorption or transmittance), electrical conductivity, magnetic coercivity, harmonic response, microwave reflection, microwave absorptions or the like.

Next to one type of non-elongated security particles, other security particles and/or particles without a security or identification function, may also be added. For example, it may be advantageous to add particles, which have an affinity with the substrate already at this stage in the sheet-like or tape-like product. In this sense, when the substrate comprises paper, it may advantageous to add cellulose particles, next to the security particles.

The non-elongated security particles may be present in the sheet-like or tape-like product in a concentration ranging from 1.0×10⁻⁶ to 1.0×10⁻³ g/cm².

The terms “a paper or plastic compatible binder” refer to a binder that can be integrated easily into a paper or plastic matrix. Either the binder disappears during the process of integration or the binder can be bound to paper or plastic.

Advantageously, the binder is a water-soluble binder. This makes the binder particularly advantageous for integration in paper.

As an example, the binder may be selected from the group consisting of polyvinyl alcohols, methyl cellulose ethers, hydroxypropylmethylcellulose, polyethers from ethylene oxide, acrylic acid polymers or acrylic copolymers.

As a matter of a preferable example, methyl cellulose has following advantages as a binder in this context: it is a cheap binder material, any shaping or mixing can be done under room conditions, reuse of the methyl cellulose and of the material mixed with it, is possible. The binder material methyl cellulose easily disintegrates when heated.

The tape-like or sheet-like product, as such, has only a transitory existence. Its purpose is to control better the concentration of the security particles and the geometry of the region of security particles. This control is done at the level of the tape-like or sheet-like material and not at the level of the final value document or value product.

Ultimately, the tape-like or sheet-like product is to integrate with the value document or value product. Once this integration step done, it is no longer possible to extract the tape-like or sheet-like material intact from the value document or value product. So during its life, the tape-like or sheet-like product must stay coherent and strong. At the time of integration with the value document or value product, the tape-like or sheet-like product must cease to exist as such.

Preferably, a plasticizer may be added and mixed together with the security particles and the binder material in the solvent. Such a plasticizer makes the sheet-like or tape-like product stronger and more flexible. An example of a plasticizer is polyethylene glycol. Another example is polyvinyl alcohol.

The plasticizer may also have another function, particularly in case the sheet-like or tape-like product is to be integrated in paper value documents. Paper manufacturing is done in a very humid atmosphere with a lot of water. Correct amounts of plasticizer present in the tape-like or sheet-like product may control the time required for the disintegration process of the tape-like or sheet-like material and its integration in the paper value documents. Next to plasticizers, titanium dioxide (TiO₂) and carbonates may also fulfill this function. The higher the amount of plasticizer, TiO₂ or carbonates, the longer the disintegration process takes.

Also color additives may be mixed together with the security particles and the binder material. This may give a particular and predetermined color to the sheet-like or tape-like product. The given color may mask the presence of security particles.

Advantageously, particularly when used with paper as substrate material, the sheet-like or tape-like product is made porous, e.g. by making small perforations in the sheet-like or tape-like product. This porosity facilitates the evacuation of water during the integration of the sheet-like or tape-like product in a paper substrate.

According to a second aspect of the present invention, there is provided a value document or a value product in which or on which the tape-like or sheet-like product has been integrated.

According to a third aspect of the present invention, there are provided two methods of manufacturing a sheet-like or tape-like product.

The first method comprises the following steps
a) providing a binder in a liquid form or loose form, e.g. in a solvent such as water;
b) providing non-elongated particles which will function as security particles;
c) mixing the particles in or with the binder;
d) casting the binder with the particles;
e) drying or heat treating the cast binder with the particles to form a coherent sheet-like or tape-like product.

One of the advantages of the present invention results from step c): the particles are mixed with the binder material in a controllable and determinable concentration. If abstraction is made of the non-security particles, possible other additives and of the solvent, the only parameters are the amount of security particles, the amount of binder material and the degree of mixing. Both the amount of security particles and the amount of binder material can be exactly determined. The degree of mixing can be easily controlled e.g. by the revolutions of a screw in the mixture and by the working temperature. The mixed particles in the binder are cast and dried or heat-treated, e.g. to vaporize the solvent, and form a coherent sheet-like or tape-like product. The concentration of the security particles in this sheet-like or tape-like product and the variations hereof can be determined on this sheet-like or tape-like product before any integration into the final product. The concentration of the security particles in the sheet-like or tape-like product is directly related to the concentration of the security particles in the final product or final document.

In an embodiment of the invention, the tape-like or sheet-like product may be cast using an applicator such as a doctor blade.

The method further comprises the step of cutting the sheet-like or tape-like product. This additional step has the advantage of exactly determining the dimensions of the location where the security particles can be found. Moreover, this exact determination is done in advance prior to the final value product or value document manufacturing. This means that this separate and prior cutting makes the whole method more robust and less dependent upon the particular way of integrating the security particles into the final value document or onto a value product.

As a subsequent step, the dried binder with the security particles is integrated in the substrate of the value document or value product.

The second method comprises the following steps:
a) providing a substrate;
b) providing non-elongated security particles in the form of metal particles or metal coated particles on the substrate;
c) casting or spraying a binder in liquid or loose form on the security particles
d) drying or heat treating the combination of binder and security particles so that a coherent sheet-like or tape-like product is obtained separable from the substrate.

In this second method, the concentration of security particles and the geometry of the region with security particles is controlled mainly in step b).

### BRIEF DESCRIPTION OF THE DRAWINGS

The invention will now be described into more detail with reference to the accompanying drawings wherein:

FIG. 1 is a drawing of a cast and dried binder mixed with non-elongated security particles;

FIG. 2a (upper view) and FIG. 2b (cross-section) show a value document of paper; and

FIG. 3a (upper view) and FIG. 3b (cross-section) show a value document of plastic.

### DESCRIPTION OF THE PREFERRED EMBODIMENTS OF THE INVENTION

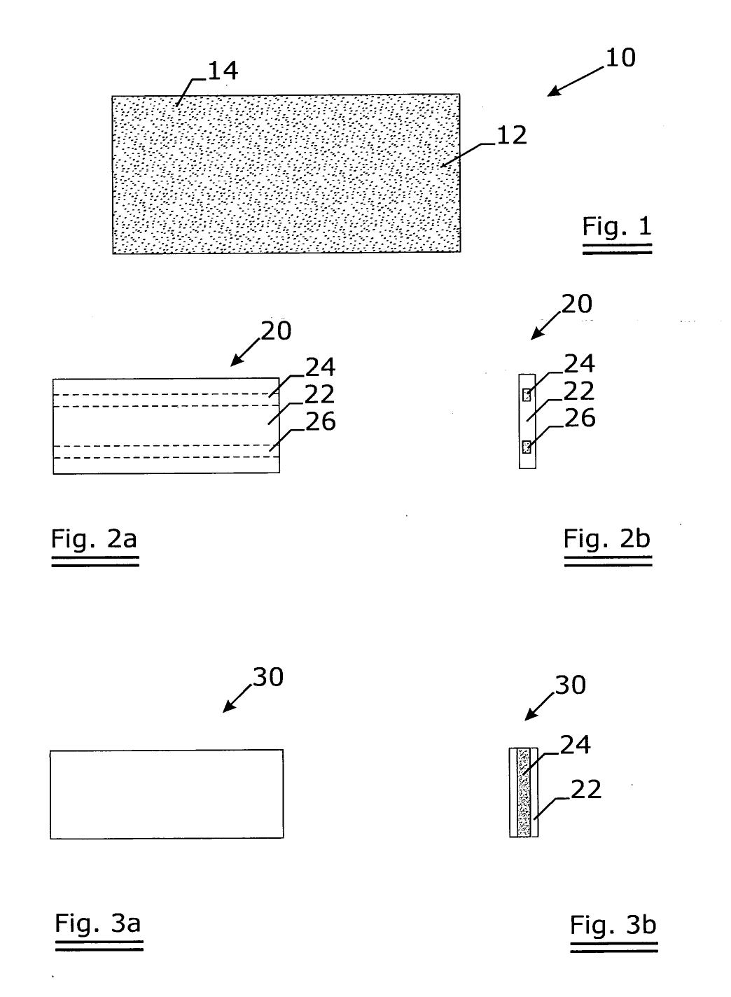

FIG. 1 shows a sheet-like or tape-like product 10 as result of the invention method. The sheet-like or tape-like product 10 comprises a cast and dried solvent with binder 12 mixed with non-elongated security particles 14.

The security particles 14 may be e.g. glass particles or powders. As a matter of example, the glass particles have diameter ranging from 0.1 μm to 30 μm.

The sheet-like or tape-like product 10 is made in the following way:
a) an amount of binder such as methyl cellulose is poured in a receptacle filled with a solvent such as water
b) a predetermined amount of non-elongated particles 14 is poured in the same receptacle;
c) the particles 14 are mixed in the methyl cellulose in order to obtain a distribution which is as homogeneous as possible; for example, the amount of particles may range from 0.1 g particles per liter solvent—methyl cellulose to 4.5 g particles per liter solvent—methyl cellulose, e.g. from 0.3 g/l to 1.5 g/l
d) the slurry solvent—methyl cellulose 12—particles 14 is cast on a flat surface, e.g. a metal surface;
e) the cast mixture is leveled to a predetermined thickness, e.g. a thickness varying between 30 μm and 500 μm, e.g. between 60 μm and 300 μm; this leveling can be done by means of a leveling lath, e.g. by means of the clearance of a doctor blade;
f) the leveled mixture is dried
g) the dried mixture may be cut to the desired lengths and widths.

Any control on the concentration itself and on the variation of the concentration of the particles 14 in the methyl cellulose can be done on the sheet-like or tape-like product 10. Any sheet-like or tape-like product not meeting the concentration specifications can be recuperated. The cutting to the desired width may allow avoiding side effects on the concentration, if any.

The concentration in the sheet-like or tape-like product may range, for example, from 0.05 g/m² to 10.0 g/m², e.g. from 0.1 g/m² to 1.0 g/m², e.g. 0.5 g/m².

FIG. 2a is an upper view and FIG. 2b a cross-section of a value document 20 with a paper substrate 22 and with two small bands 24, 26 comprising non-elongated particles. An example of such a value document may be a bank note. The two small bands 24 originate from the sheet-like or tape-like product 10, which has been cut in advance to the desired width. As a result, the width can be determined with more accuracy than in the prior art case where the loose particles are being integrated into the paper substrate during the paper manufacturing process. If the binder material is methyl cellulose dissolved in a solvent as water, it may dissolve partially or completely during the integration into the paper substrate as a result of the water used during paper manufacturing and the heat produced during paper manufacturing. This ‘disappearance’, however, has no negative influence on the concentration and the distribution of the particles in the document.

FIG. 3a is an upper view and FIG. 3b is a cross-section of a value document 30 with a plastic substrate 32 and with a layer 34 comprising particles. An example of such a value document may be a credit card or a plastic bank note. The value document 30 may be made by laminating the sheet-like or tape-like product 10 with the non-elongated particles 14 between two plastic foils 32. Here again, if methyl cellulose dissolved in a solvent as water is used as binder material, it may disappear partially or completely as a result of the heat generated during lamination.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

1. A coherent sheet-like or tape-like product adapted to be integrated into value products or documents, said product comprising:
a) non-elongated security particles; and
b) a paper or plastic compatible binder.

2. A sheet-like or tape-like product according to claim 1, wherein:
a) said sheet-like or tape-like product has a concentration of security particles varying from 1.0×10⁻⁶ g/cm² to 1.0×10⁻³ g/cm².

3. A sheet-like or tape-like product according to claim 2, wherein:
a) said binder is water soluble.

4. A sheet-like or tape-like product according to claim 3, wherein:
a) said binder is selected from the group consisting of polyvinyl alcohols, methyl cellulose ethers, hydroxypropyl methylcellulose, polyethers from ethylene oxide, acrylic acid polymers or acrylic copolymers.

5. A sheet-like or tape-like product according to claim 4, wherein:
a) said product further includes a plasticizer, titanium dioxide, or carbonates.

6. A sheet-like or tape-like product according to claim 5, wherein
a) said plasticizer is polyethylene glycol or polyvinylalcohol or a combination of both.

7. A sheet--like or tape like product according to claim 6, wherein:
a) said product is provided with porosities to facilitate water evacuation.

8. A value document comprising a sheet-like or tape-like product according to claim 1.

9. A method of manufacturing a sheet-like or tape-like product according to claim 7, said method comprising the following steps:
a) providing a binder in a liquid or loose form;
b) providing non-elongated security particles;
c) mixing said particles in said binder;
d) casting said binder with said particles; and
e) drying or heat treating said cast binder with said particles to form said sheet-like or tape-like product.

10. A method of manufacturing a sheet-like or tape-like product according to claim 7, said method comprising the following steps:
a) providing a substrate;
b) providing non-elongated security particles on said substrate;
c) casting or spraying a binder in liquid or loose form on said security particles; and
d) drying or heat treating said combination of binder and security particles so that a coherent sheet-like or tape-like product is obtained separable from said substrate.

11. A sheet-like or tape-like product according to claim 1, wherein:
a) said binder is water soluble.

12. A sheet-like or tape-like product according to claim 2, wherein:
a) said product further includes a plasticizer, titanium dioxide, or carbonates.

13. A sheet-like or tape-like product according to claim 1, wherein:
a) said product further includes a plasticizer, titanium dioxide, or carbonates.

14. A sheet-like or tape-like product according to claim 5, wherein:
a) said product is provided with porosities to facilitate water evacuation.

15. A sheet-like or tape like product according to claim 1, wherein:
a) said product is provided with porosities to facilitate water evacuation.

16. A method of manufacturing a sheet-like or tape-like product according to claim 1, said method comprising the following steps:
a) providing a binder in a liquid or loose form;
b) providing non-elongated security particles;
c) mixing said particles in said binder;
d) casting said binder with said particles; and
e) drying or heat treating said cast binder with said particles to form said sheet-like or tape-like product.

17. A method of manufacturing a sheet-like or tape-like product according to claim 1, said method comprising the following steps:
a) providing a substrate;
b) providing non-elongated security particles on said substrate;
c) casting or spraying a binder in liquid or loose form on said security particles; and
d) drying or heat treating said combination of binder and security particles so that a coherent sheet-like or tape-like product is obtained separable from said substrate.
